(19) United States
(12) Patent Application Publication
(10) Pub. No.: US 2026/0264680 A1
(43) Pub. Date: Sep. 10, 2026

(54) METHOD AND DEVICE FOR DETERMINING READINESS OF A DRIVER ASSIST FUNCTION

(71) Applicant: VOLKSWAGEN AKTIENGESELLSCHAFT, Wolfsburg (DE)

(72) Inventors: Felix STAHL, Braunschweig (DE); Jonas KASTE, Alfeld (DE); Felix KALLMEYER, Wolfsburg (DE); Thomas GÜNTERBERG, Wolfsburg (DE)

(21) Appl. No.: 19/473,850

(22) PCT Filed: Apr. 9, 2024
(86) PCT No.: PCT/EP2024/059610

§ 371 Date: Oct. 9, 2025

(30) Foreign Application Priority Data
Apr. 18, 2023 (DE) 10 2023 203 517.0

(51) Int. Cl. B60W 30/16; G06N 3/08

(52) U.S. Cl. CPC B60W 30/16; G06N 3/08; B60W 2540/223; B60W 2554/4041

(57) ABSTRACT

A method for determining readiness of a driver assist function, wherein a rules-based decision logic circuit is used to generate a first enable signal on the basis of captured and/or requested first status data, wherein, using a machine learning-based decision logic circuit, a second enable signal is generated on the basis of captured and/or requested second status data, wherein an enable display signal is generated and provided, wherein the display signal is activated if the first enable signal is present, wherein the display signal is deactivated after activation by the first enable signal only if the first enable signal and the second enable signal are no longer present. Also disclosed is a device for determining readiness of a driver assist function.

### PRIORITY CLAIM AND CROSS REFERENCE

This patent application is a U.S. National Phase of International Patent Application No. PCT/EP2024/059610, filed 9 Apr. 2024, which claims priority to German Patent Application No. 10 2023 203 517.0, filed 18 Apr. 2023, the disclosures of which are incorporated herein by reference in their entireties.

### FIELD

Illustrative embodiments relate to a method and to a device for determining readiness of a driver assist function.

### SUMMARY

Disclosed embodiments improve a method and a device for determining readiness of a driver assist function, in particular with respect to feedback to a driver.

For example, a method for determining readiness of a driver assist function is provided, wherein a first approval signal is generated by a rule-based decision logic based on detected and/or requested first status data, wherein a second approval signal is generated by a machine learning-based decision logic based on detected and/or requested second status data, wherein an indicator signal for an approval is generated and provided, wherein the indicator signal is activated if the first approval signal is present, wherein the indicator signal is only deactivated after activation by the first approval signal when the first approval signal and the second approval signal are no longer present.

### BRIEF DESCRIPTION OF THE DRAWINGS

Disclosed embodiments will be described in more detail below with reference to drawings, in which:

FIG. 1 shows a schematic representation to illustrate embodiments of the device; and

FIG. 2 shows a schematic flow chart of an embodiment of the method.

### DETAILED DESCRIPTION

In modern transportation vehicles, drivers are assisted by driver assist systems which provide driver assist functions. Examples thereof are automated or semiautomated longitudinal and/or lateral guidance of the transportation vehicle. Currently, it is still typical for the driver to have to arrange their hands on the steering wheel at regular intervals so that automated or semiautomated operation is possible. Otherwise, the driver assist function is deactivated. Various sensors and/or methods can be used to detect at least one hand on the steering wheel (also referred to as hands-on detection).

For example, it can be established by a capacitive sensor on a steering wheel of the transportation vehicle whether or not at least one hand of the driver is located on the steering wheel. A multistage status (e.g., no contact, lightly grasped on the left/right to strongly grasped on both sides, etc.) can be determined from the capacitively detected sensor data, for example, which status is transmitted, for example, to assistance functions, such as a longitudinal and/or lateral guidance assist system. For example, such a status can be fed to an Adaptive Cruise Control (ACC) as an input, wherein, if contact of at least one hand with the steering wheel is established, for example, a driving-off procedure to follow a preceding transportation vehicle is approved. Furthermore, driver observation cameras are known, which can recognize a driver activity.

In addition, there are methods which recognize a driver activity, in particular with respect to hands-on detection, by methods of artificial intelligence (machine learning) or rule-based approaches. For example, a method of artificial intelligence, in particular an artificial neural network, can be trained to carry out hands-on detection starting from a torque detected on a steering system, a detected steering angle and/or changes of these variables.

Such a method is known, for example, from US 2022/0161846 A1. The rule-based approach, in contrast, passively evaluates steering signals (e.g., a steering torque, a steering speed and/or a steering angle) in relation to threshold values and/or signal profiles and/or operates actively using a torque application, in which a test signal is applied to the steering wheel by an actuator, which is to induce a counter torque of hands arranged on the steering wheel that can be detected by a sensor.

As soon as such a counter torque has been detected, it is assumed that at least one hand is arranged on the steering wheel. Such a method is known, for example, from DE10 2013209459A1.

If, for example, a capacitive sensor on the steering wheel is to be omitted for reasons of cost, a rule-based approach and a machine learning-based approach can thus be used. The rule-based approach is less sensitive, so that a state in which a hand is arranged on the steering wheel but no steering movements currently take place cannot always be reliably recognized. A machine learning-based approach is more sensitive, but approving the driver assist function exclusively based on the machine learning-based approach is presently not possible due to regulatory provisions.

The disclosed embodiments improve a method and a device for determining readiness of a driver assist function, in particular with respect to feedback to a driver.

In particular, a method for determining readiness of a driver assist function is provided, wherein a first approval signal is generated by a rule-based decision logic based on detected and/or requested first status data, wherein a second approval signal is generated by a machine learning-based decision logic based on detected and/or requested second status data, wherein an indicator signal for an approval is generated and provided, wherein the indicator signal is activated if the first approval signal is present, wherein the indicator signal is only deactivated after activation by the first approval signal when the first approval signal and the second approval signal are no longer present.

Furthermore, in particular, a device for determining readiness of a driver assist function is provided, comprising a data processing apparatus, wherein the data processing apparatus is configured to receive detected and/or requested first status data and to provide a rule-based decision logic which generates a first approval signal based on the detected and/or requested first status data, furthermore to receive detected and/or requested second status data and to provide a machine learning-based decision logic which generates a second approval signal based on the detected and/or requested second status data, furthermore to generate and to provide an indicator signal for approval, and to activate the indicator signal when the first approval signal is present, and to only deactivate the indicator signal after activation by the first approval signal when the first approval signal and the second approval signal are no longer present.

The method and the device enable an indicator signal to be provided which makes feedback about availability of the driver assist function, in particular in conjunction with hands-on detection, less confusing for a driver. This is based on the concept that the indicator signal for indicating readiness of the driver assist function is provided or is activated exclusively depending on the first approval signal, i.e., the indicator signal is activated only when the first approval signal is present. To nonetheless signal fundamental availability to the driver, the indicator signal is only deactivated after activation by the first approval signal provided by the rule-based decision logic after discontinuation of this first approval signal (because the rule-based decision logic can no longer recognize a hand on the steering wheel) when the second approval signal which is provided by the more sensitive machine learning-based decision logic is also no longer present. In this way, an indication can be actuated by the indicator signal, which indication can signal the availability of a driver assist function of the driver assist system in an improved manner. In particular in the case of a repeated status change, i.e., when the rule-based decision logic changes back and forth repeatedly in a short time between recognition and nonrecognition, the indication can remain actively switched in this way to indicate the fundamental availability of the driver assist function to the driver. Repeated changing back and forth of the indication can be avoided in this way. However, the real availability and provision of the driver assist function is still determined in particular by the presence of the first approval signal. The second approval signal exclusively affects the indicator signal and the indication. A status representation can be made less confusing and more reliable for the driver in this way. This enhances driving comfort and trust in the technology.

The rule-based decision logic in particular passively evaluates the first status data and derives the first approval signal on the basis thereof in a rule-based manner, for example by comparing the first status data to predetermined threshold values. For example, steering signals (e.g., a steering torque, a steering speed and/or a steering angle) can be evaluated in relation to threshold values and/or signal profiles. As described in the introduction, a test signal can also be actively applied to a steering wheel to induce and to detect a counter torque. For example, hands-on detection can be carried out based on a detected torque, a detected steering angle and/or changes of these variables, wherein the first approval signal codes a hands-on status.

The machine learning-based decision logic can be provided based on a method of artificial intelligence, in particular an artificial neural network, wherein the artificial intelligence or the neural network is trained to assess the second approval signal based on the first status data. The training and application of the method of artificial intelligence, in particular of the neural network, take place in a manner known per se for this purpose. For example, hands-on detection can be carried out based on a detected torque, a detected steering angle and/or changes of these variables, wherein the second approval signal codes a hands-on status.

Parts of the device, in particular the data processing apparatus, can be designed individually or in combined form as a combination of hardware and software, for example, as program code which is executed on a microcontroller or microprocessor. However, it can also be provided that parts are designed individually or in combined form as an application-specific integrated circuit (ASIC) and/or field-programmable gate array (FPGA).

In at least one embodiment, it is provided that the driver assist function is only approved when the first approval signal is present. It can be ensured in this way that the driver assist function-independently of the indicator signal and an output of the indicator signal at an indicator-is provided exclusively based on the presence of the first approval signal, i.e., is activated and deactivated.

In at least one embodiment, it is provided that the first approval signal and the second approval signal represent contact of at least one hand with a steering wheel. In particular, the first approval signal and the second approval signal contain and/or code a result of hands-on detection.

In at least one exemplary embodiment, it is provided that the driver assist function is an adaptive cruise control (ACC). The indicator signal can then indicate, for example, a readiness of the adaptive cruise control to drive off from a standstill to follow a preceding transportation vehicle.

In a refining exemplary embodiment, it is provided that an active test signal is applied to the steering wheel if the first approval signal is not present and it is possible to follow a preceding transportation vehicle. In this way, a torque can be applied to the steering wheel to carry out hands-on detection. In particular, this permits a hand on the steering wheel to be recognized in a short time to activate the driver assist function nearly without delay (after recognition of at least one hand on the steering wheel) even with deactivated driver assist function and to carry out the driving-off to follow a preceding transportation vehicle.

Further features for designing the device result from the description of designs of the method. The benefits of the device are each the same in this case as in the designs of the method.

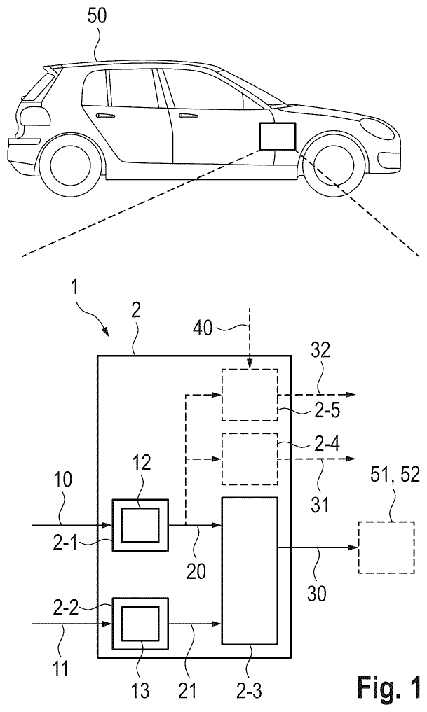

FIG. 1 shows a schematic representation to illustrate exemplary embodiments of the device 1. The device 1 is arranged in a transportation vehicle 50, in particular a transportation vehicle. The device 1 can itself provide a driver assist function or can control the provision of such a function.

The device 1 comprises a data processing apparatus 2. The data processing apparatus 2 comprises, for example, a computing apparatus, for example, a microprocessor, and a memory (both not shown) to carry out method steps of the method described in this disclosure.

The data processing apparatus 2 is configured to receive detected and/or requested first status data 10 and to provide a rule-based decision logic 12 which generates a first approval signal 20 based on the detected and/or requested first status data 10. For this purpose, the data processing apparatus 2 comprises, for example, a module 2-1 which can also be designed as a software module. The detected and/or requested first status data 10 originate, for example, from sensors of the transportation vehicle 50, for example, a steering angle sensor and/or a torque sensor of a steering system of the transportation vehicle 50. The first approval signal 20 can in particular include the statuses active (or “on” or “1”) or inactive (or “off” or “0”) and can be provided as a corresponding signal level.

Furthermore, the data processing apparatus 2 is configured to receive detected and/or requested second status data 11 and to provide a machine learning-based decision logic 13 which generates a second approval signal 21 based on the detected and/or requested second status data 11. For this purpose, the data processing apparatus 2 comprises, for example, a module 2-2 which can also be designed as a software module. The detected and/or requested second status data 11 likewise originate, for example, from sensors of the transportation vehicle 50, for example, a steering angle sensor and/or a torque sensor of a steering system of the transportation vehicle 50. The second approval signal 21 can in particular include the statuses active (or “on” or “1”) or inactive (or “off” or “0”) and can be provided as a corresponding signal level.

The first status data 10 and the second status data 11 can in principle be the same or different. For example, the status data 10, 11 can originate from the same sensors or different types of sensors and/or sensors can be used.

Furthermore, the data processing apparatus 2 is configured to generate and to provide an indicator signal 30 for an approval, and to activate the indicator signal 30 when the first approval signal 20 is present, and only to deactivate the indicator signal 30 after activation by the first approval signal 20 when the first approval signal 20 and the second approval signal 21 are no longer present. For this purpose, the data processing apparatus 2 comprises, for example, a module 2-3 which can also be designed as a software module and which evaluates the first approval signal 20 and the second approval signal 21 and generates the indicator signal 30 according to the described logic.

The indicator signal 30 can be used, for example, to actuate an indicator 51 in the transportation vehicle 50 or can be indicated on an indication apparatus 52 of the transportation vehicle 50.

It can be provided that the data processing apparatus 2 is configured to approve the driver assist function only when the first approval signal 20 is present. For this purpose, the data processing apparatus 2 can comprise a module 2-4 which checks the presence of the first approval signal 20 and approves or blocks the driver assist function on the basis thereof. For example, a control signal 31 can be generated and provided for this purpose. The module 2-4 can also be designed as a software module.

It can be provided that the first approval signal 20 and the second approval signal 21 represent contact of at least one hand with a steering wheel of the transportation vehicle 50. The first status data 10 and the second status data 11 can then comprise, for example, sensor data of a steering angle sensor and/or of a torque sensor.

It can be provided that the driver assist function is an adaptive cruise control (ACC). The indicator signal 20 can in this case signal readiness to follow a preceding transportation vehicle.

It can be provided that the data processing apparatus 2 is configured to cause the application of an active test signal to the steering wheel if the first approval signal 20 is not present and it is possible to follow a preceding transportation vehicle. For this purpose, the data processing apparatus 2 comprises, for example, a module 2-5 which can also be designed as a software module. In particular, a trigger signal 32 is generated to cause the application of the active test signal in a way known per se. The module 2-5 can furthermore receive a readiness signal 40 of the adaptive cruise control for this purpose with the content that following is possible (or not) at the current time.

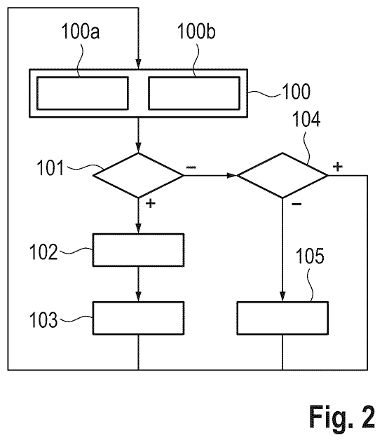

FIG. 2 shows a schematic flow chart of an exemplary embodiment of the method for determining readiness of a driver assist function.

In a method step 100, method steps 100a and 100b are carried out. In method step 100a, a first approval signal is generated by a rule-based decision logic based on detected and/or requested first status data. In method step 100b, a second approval signal is generated by a machine learning-based decision logic based on detected and/or requested second status data. The approval signals can be generated, for example, in the form of signal levels, wherein two signal levels are provided in each case to code two statuses (for example, “yes” or “no” or, respectively, “1” or “0”).

In a method step 101, it is checked whether or not the first approval signal generated in method step 100a is present. If this is the case, a driver assist function of the driver assist system is activated in a method step 102. Furthermore, in a method step 103, a generated and provided indicator signal for an approval is activated, for example, in that a signal level of the indicator signal that is intended for this purpose is set. The sequence then jumps back to method step 100.

In contrast, if the check in method step 101 shows that the first approval signal is not present, it is checked in a method step 104 whether or not the second approval signal generated in method step 100b is present. If this is the case, the sequence jumps back to method step 100. In contrast, if this is not the case, the indicator signal is deactivated in a method step 105, for example, in that a signal level intended for this purpose is set. The sequence then jumps back to method step 100.

The indicator signal can therefore only be activated if the first approval signal is present. In contrast, the deactivation upon discontinuation of the first approval signal is delayed if the second approval signal is still present after a discontinuation of the first approval signal. If the second approval signal is also discontinued, the indicator signal is deactivated. A renewed activation can then only take place due to a renewed presence of the first approval signal.

In particular, it is provided that the first approval signal and the second approval signal represent contact of at least one hand with a steering wheel.

Furthermore, it is provided in particular that the driver assist function is an adaptive cruise control. The indicator signal can indicate, for example, readiness of the adaptive cruise control to follow a preceding transportation vehicle.

It can be provided that an active test signal is applied to the steering wheel if the first approval signal is not present and it is possible to follow a preceding transportation vehicle.

### LIST OF REFERENCE SIGNS

1 device
2 data processing apparatus
2-1 module
2-2 module
2-3 module
2-4 module
10 first status data
11 second status data
12 rule-based decision logic
13 machine learning-based decision logic
20 first approval signal
21 second approval signal
30 indicator signal
31 control signal
32 trigger signal
40 readiness signal
50 transportation vehicle
51 indication
52 indicator apparatus
100-105 method steps

1. A method for determining readiness of a driver assist function of a transportation vehicle, the method comprising:
generating a first approval signal using a rule-based decision logic based on detected and/or requested first status data;
generating a second approval signal using a machine learning-based decision logic based on detected and/or requested second status data;
generating and providing an indicator signal for an approval wherein the indicator signal is activated when the first approval signal is present;
deactivating the indicator signal after activation by the first approval signal in response to the first approval signal and the second approval signal no longer being present.

2. The method of claim 1, wherein the driver assist function is only approved when the first approval signal is present.

3. The method of claim 1, wherein the first approval signal and the second approval signal represent contact of at least one hand with a steering wheel.

4. The method of claim 1, wherein the driver assist function is an adaptive cruise control.

5. The method of claim 4, wherein an active test signal is applied to the steering wheel when the first approval signal is not present and it is possible for the transportation vehicle to follow a preceding vehicle.

6. A device for determining readiness of a driver assist function of a transportation vehicle, the device comprising:
a data processing apparatus,
wherein the data processing apparatus is configured to:
receive detected and/or requested first status data and provide a rule-based decision logic which generates a first approval signal based on the detected and/or requested first status data,
receive detected and/or requested second status data and provide a machine learning-based decision logic which generates a second approval signal based on the detected and/or requested second status data, and
generate and provide an indicator signal for an approval, activate the indicator signal when the first approval signal is present, and only deactivate the indicator signal after activation by the first approval signal in response to the first approval signal and the second approval signal being no longer present.

7. The device of claim 6, wherein the data processing apparatus is configured to approve the driver assist function only when the first approval signal is present.

8. The device of claim 6, wherein the first approval signal and the second approval signal represent contact of at least one hand with a steering wheel.

9. The device of claim 6, wherein the driver assist function is an adaptive cruise control.

10. The device of claim 9, wherein the data processing apparatus is configured to cause the application of an active test signal to the steering wheel when the first approval signal is not present and it is possible to follow a preceding vehicle.
